(19) United States
(12) Patent Application Publication
(10) Pub. No.: US 2025/0065673 A1
(43) Pub. Date: Feb. 27, 2025

(54) HEAVY TRUCK TIRE TREAD WITH RIB ELEMENT TO MANAGE IRREGULAR WEAR

(71) Applicants: Virgile AYGLON, Greenville, SC (US); Stefan VOSS, Greenville, SC (US); COMPAGNIE GENERALE DES ETABLISSEMENTS MICHELIN, Clermont-Ferrand (FR)

(72) Inventors: Virgile AYGLON, Simpsonville, SC (US); Stefan VOSS, Greer, SC (US)

(21) Appl. No.: 18/724,254

(22) PCT Filed: Dec. 31, 2021
(86) PCT No.: PCT/US2021/065814

§ 371 Date: Jun. 26, 2024

(51) Int. Cl. B60C 11/12; B60C 11/03; B60C 11/13

(52) U.S. Cl. CPC B60C 11/1236; B60C 11/13; B60C 2011/0341; B60C 2200/06

(57) ABSTRACT

A heavy truck tire tread is provided that has an outer surface and a circumferential groove (24) that extends in the circumferential direction completely around the tread. A rib (26) is present that has a rib element (28) that defines a portion of the circumferential groove (24) and has an upper surface (30) in the radial direction. The upper surface has a leading edge (32) and a tailing edge (34) in the circumferential direction. The leading edge (32) and the tailing edge (34) are at different distances to the central axis in the radial direction. A first micro sipe (40) extends into the rib and opens into the circumferential groove (24), and a second micro sipe (42) extends into the rib (26) and opens into the circumferential groove (24). The rib element (28) extends from the first micro sipe (40)) to the second micro sipe (42) in the circumferential direction.

### FIELD OF THE INVENTION

The subject matter of the present invention relates to a heavy truck tire tread that has improved irregular wear performance. More particularly, the present application involves a tread that has a rib element with an upper surface without the same distance to a central axis so that coupling force is increased to reduce irregular wear.

### BACKGROUND OF THE INVENTION

Manufacturers of heavy commercial vehicle tires have historically been challenged with difficulty in improving the wear life of these tires, especially steer tires, due to the onset of irregular wear that leads to the early removal of these tires from service. Attempts to increase wear life have included increasing lateral rigidity by reducing the number of ribs in the sculpture. However, such modifications can lead to a reduction in wet traction performance due to the loss of a tread groove. One design feature that has been implemented to protect tires, typically steer tires, from irregular wear is the use of small, directional micro sipes at rib edges. These micro sipes are small sipes that protect the rib edges by reducing edge stresses. These rib edges can be located at the two lateral ends of the tread or are adjacent, sacrificial ribs of the tire which are in turn at the two lateral ends of the tread. Micro sipes can also be located in ribs of the tread that are adjacent other circumferential grooves, whether at the shoulder or spaced from the shoulder in the lateral direction.

The orientation of the micro sipes so as to be at an angle to the radial direction of the tire generates a tangential (coupling) force when a vertical load is applied to the tire. However, the amount of protection this coupling force provides may not be sufficient in all instances, especially when low hysteresis compounds are used in the construction of the tread. One way to increase the amount of coupling force so that the micro sipes generate more irregular wear protection is by further increasing the non-radial inclination angle of the micro sipes. However, mold manufacturing technology limits the amount of inclination that can be achieved for the micro sipes, especially for a feature with small spacing from one to the next in the circumferential direction. One may also increase the width and/or depth of the micro sipe to increase its protective properties, but doing so reduces rigidity of the rib into which the micro sipes are disposed thus leading to a reduction of wear performance. Also, increasing the depth and/or width of the micro sipes may decrease the tread's resistance to aggression damage. As such, there remains room for variation and improvement within the art.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a prior art heavy truck tire.

FIG. 2 is a perspective view of a section of a prior art heavy truck tire tread that has circumferential grooves and micro sipes.

FIG. 3 is a perspective view of a section of a heavy truck tire tread in accordance with one embodiment.

FIG. 4 is a close-up perspective view of the embodiment of FIG. 3 showing the rib element.

FIG. 5 is a side view taken from inside the circumferential groove of FIG. 3 showing the side of the rib elements.

FIG. 6 is a top view of the embodiment of FIG. 3 showing a section of the tread.

FIG. 7 is a perspective view of a section of a heavy truck tire tread in accordance with another exemplary embodiment.

FIG. 8 is a side view taken from inside the circumferential groove of FIG. 7 showing the side of the rib elements.

FIG. 9 is a side view taken from inside of a circumferential groove of rib elements in accordance with yet another embodiment.

FIG. 10 is a perspective view of a rib element with a rounded outer surface in accordance with an additional embodiment.

The use of identical or similar reference numerals in different figures denotes identical or similar features.

### DETAILED DESCRIPTION OF THE INVENTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

The present invention provides for a heavy truck tire tread 12 for a heavy truck tire 10 that has a rib 26 with a rib element 28 that is adjacent and defines a portion of a circumferential groove 24. A plurality of micro sipes 40, 42 extend from the circumferential groove 24 in the lateral direction 18 and are angled relative to the circumferential direction 14. The rib element 28 has an upper surface 30 with a leading edge 32 and tailing edge 34 relative to the circumferential direction 14. The edges 32 and 34 are located at different distances 36, 38 to the central axis 16 in the radial direction 20. This architecture cause a change in the amount of coupling force that is provide by the micro sipe 40, 42 and rib element 28 arrangement which can improve the resistance of the tread 12 to irregular wear

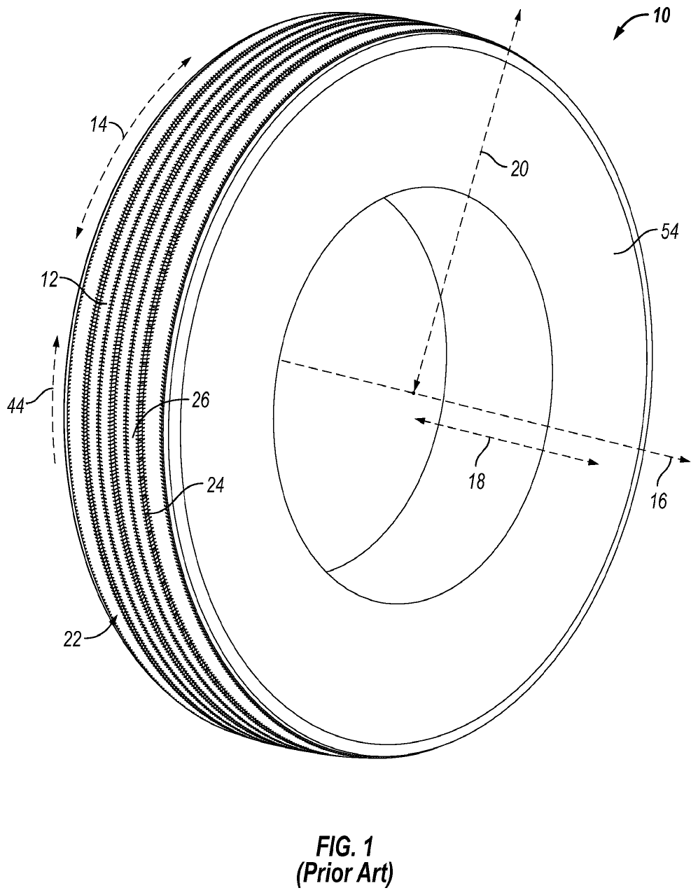

FIG. 1 shows a tire 10 that is a heavy duty truck tire 10. In this regard, the tire 10 is not designed for nor used with a car, motorcycle, or light truck (payload capacity less than 4,000 pounds), but is instead designed for and used with heavy duty trucks such as 18 wheelers, garbage trucks, or box trucks. The tire 10 may be a steer tire, a drive tire, a trailer tire, or an all position tire. The tire 10 includes a casing 54 onto which a tread 12 is disposed thereon. The tread 12 can be manufactured with the casing 54 and formed as a new tire 10, or the tread 12 can be a retread band that is attached to the casing 54 at some point after the casing 54 has already been used to form a retreaded tire 10. This is the case with all of the designs shown and described herein. They may all be tread designs of a brand new tire 10, or may be tread designs of a tread 12 for use in a retread tire 10. The central axis 16 of the tire 10 extends through the center of the casing 54, and the lateral direction 18 of the tire 10 is parallel to the central axis 16. The radial direction 20, referred to also as the thickness direction 20, of the tire 10 is perpendicular to the central axis 16 and the tread 12 is located farther from the central axis 16 in the thickness direction 20 than the casing 54. The tread 12 extends all the way around the casing 54 in the circumferential direction 14, also referred to as the longitudinal direction 14, of the tire 10 and circles the central axis 360 degrees. The tread 12 includes a series of grooves and ribs that form a tread pattern.

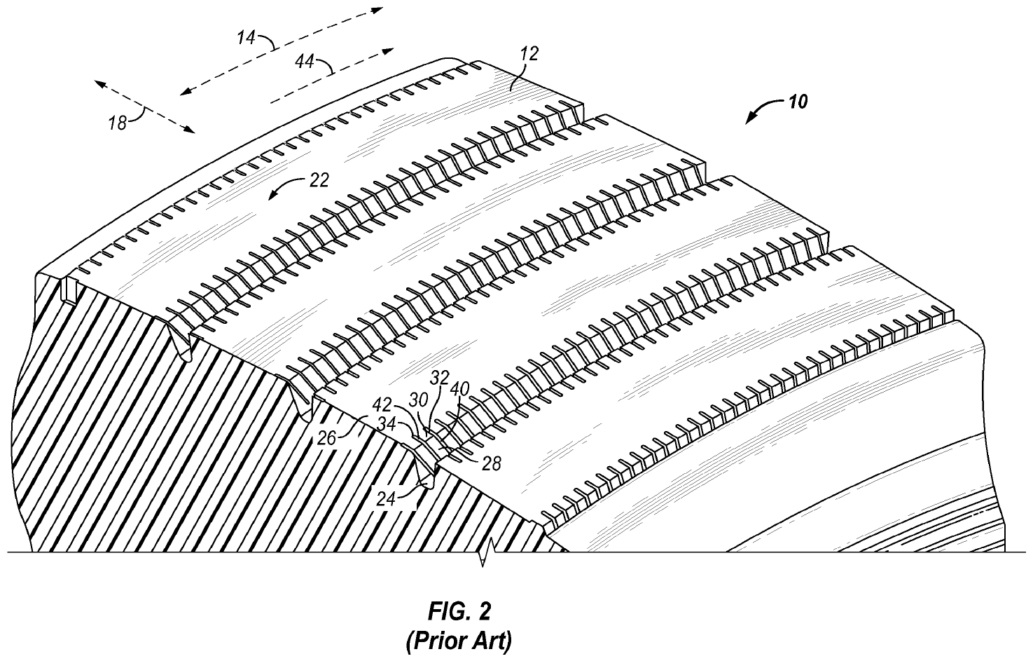

The tread 12 can be part of a tire 10 or a retread band that is produced and subsequently attached to a casing 54 to form a retread tire 10. The same tread pattern can repeat throughout the entire longitudinal length of the tread 12 in the circumferential direction 14. With reference to FIG. 2, a more detailed view of a prior tread 10 is shown that includes a number of circumferential ribs and grooves. One of the circumferential ribs 26 is adjacent one of the circumferential grooves 24 and these features extend completely around the circumferential length of the tire 10. At the lateral ends of the tread 12, sacrificial ribs are present and are adjacent the shoulder ribs separated therefrom via decoupling grooves.

The grooves of the tread 10, such as the circumferential groove 24, have widths that are 2 millimeters or larger. Sipes are features of the tread 12 that are smaller cuts within the tread 12 that have widths smaller than that of the grooves. The ribs include a series of micro sipes 40, 42 that are spaced from one another in the circumferential direction 14 and the plurality extends completely around the tread 12. These micro sipes 40, 42 have a width that is less than 2 millimeters. Micro sipes 40, 42 are sipes and can be thought of as a subset of sipes in that they extend a relatively short length across the tread 12 in the lateral direction 18. In most instances, the micro sipes 40, 42 are blind in that they terminate within the rib 26 and do not extend all the way between laterally adjacent circumferential grooves. Although four ribs are present along with the two sacrificial ribs, any number of ribs can be present in accordance with other embodiments and in these other embodiments the two sacrificial ribs may or may not be present.

The rolling direction 44 is the direction in the circumferential direction 14 the tread 12 is designed to rotate. The various features of the tread 12 can be arranged so that the tread 12 experiences improved irregular wear performance characteristics when the tread 12 rotates in the rolling direction 44, as opposed to opposite the rolling direction 44. This improvement will generally lead to an increased removal mileage, since tires 10 with irregular wear may be removed from service well before reaching the normal removal tread depth or wear bars. Some of these directional features could be the angularity of grooves and sipes within the tread 12. Although described with respect to directional treads 12, the tread 12 need not be directional in accordance with various exemplary embodiments.

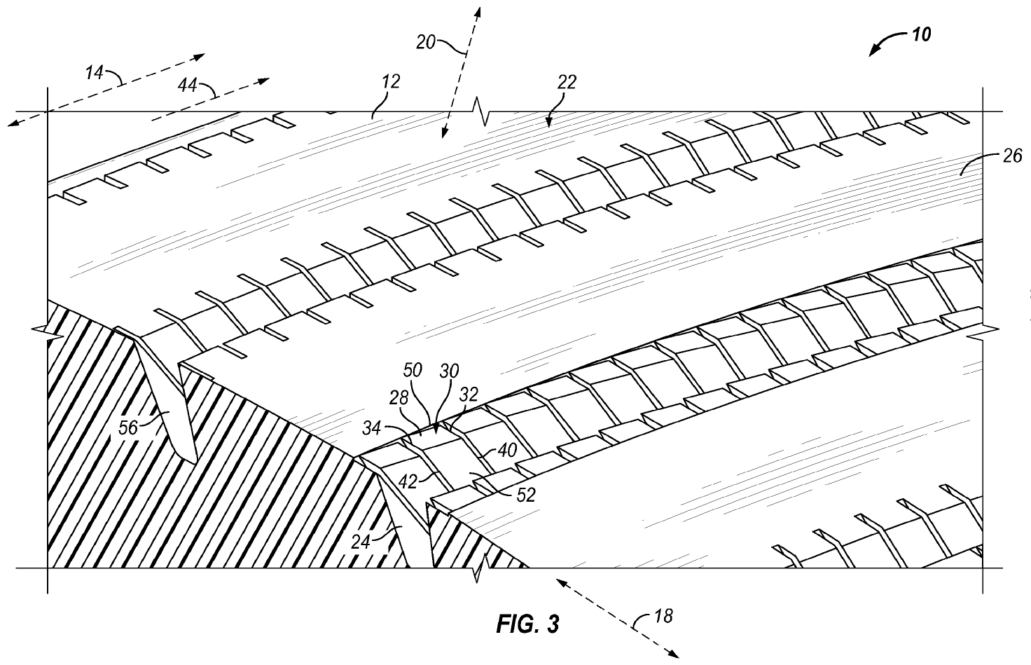

FIGS. 3-6 show one exemplary embodiment of the tread 12. The tread 12 includes a rib 26 and a circumferential groove 24 that is adjacent to and partially defined by the rib 26. A series of micro sipes 40, 42 are positioned around the entire circumferential length of the rib 26 and are open into the circumferential groove 24 and terminate within the rib 26 so as to be blind. The micro sipes 40, 42 are open at the outer surface 22 of the tread 12. The first micro sipe 40 and the second micro sipe 42 define a rib element 28 of the rib 26 as the rib element 28 is located in the circumferential direction 14 between the micro sipes 40, 42 such that the rib element 28 extends from the first micro sipe 40 to the second micro sipe 42. The rib element 28 is thus a portion of the rib 26 that is at the end of the rib 26 between the micro sipes 40, 42 and is in this instance adjacent the circumferential groove 24 and defining a portion thereof.

The part of the outer surface 22 that is the outer surface of the rib element 28 is designated as the upper surface 30. This upper surface 30 is more generally oriented in the radial direction 20, while the inner side of the rib element 28 is more generally oriented in the lateral direction 18 and defines a portion of the circumferential groove 24. The upper surface 30 is not oriented so as to have a surface normal that extends in the radial direction 20, but instead the upper surface 30 is angled or otherwise varied in depth to the central axis 16 such that some of the upper surface 30 is closer to the central axis 16 than other portions of the central axis 16. As shown in FIG. 3, another circumferential groove 56 adjacent circumferential groove 24 is illustrated and features rib elements that do not have upper surfaces 30 that are configured in this manner. Instead, the upper surfaces of the rib elements adjacent circumferential groove 56 all have surface normals that extend completely in the radial direction 20. The upper surface 30 associated with the circumferential groove 24 can be present on all of the rib elements in all of the grooves of the tread 12, or only on certain ones of the circumferential grooves of the tread 12. Further, the upper surfaces 30 associated with the circumferential groove 24 can be present on the shoulder rib adjacent the decoupling groove if present, and can be located in the sacrificial rib as well.

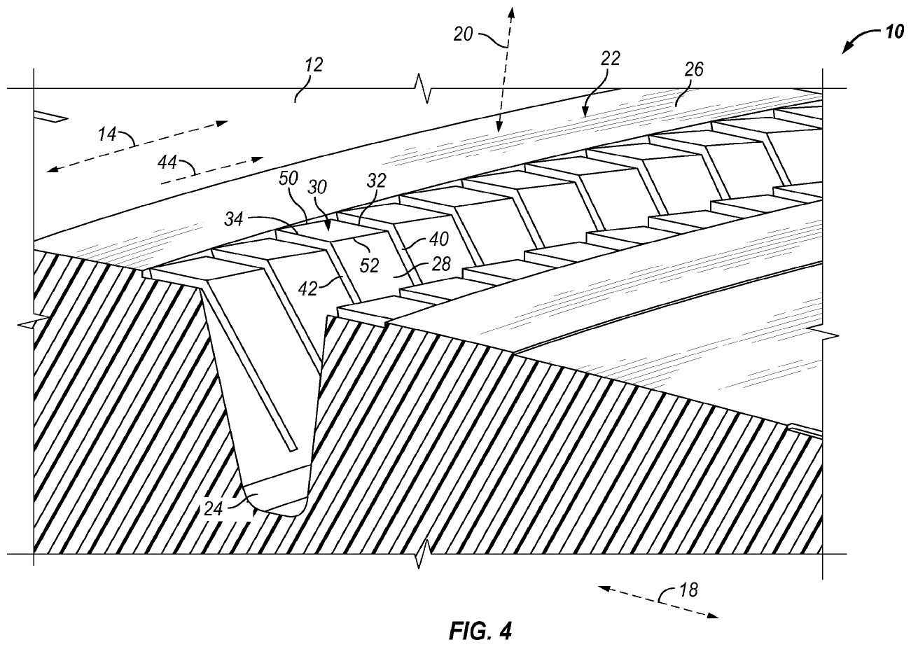

FIG. 4 is a close-up view of the circumferential groove 24 of FIG. 3 and shows additional detail from within the circumferential groove 24. The micro sipes 40, 42 can extend to a position in the radial direction 20 near, but not all the way to, the bottom of the circumferential groove 24. The very bottom of the circumferential groove 24 may be closer to the central axis 16 than the bottoms of the micro sipes 40, 42 are to the central axis 16 in the radial direction 20. All of the upper surfaces 30 are configured and oriented the same way on all of the rib elements 28 extending about the tread 12. The outer surface 22 of the rib 26 adjacent the upper surfaces 30 is smooth and located at the same distance from the central axis 16 in the radial direction 20. The upper surfaces 30 on both sides of the circumferential groove 24 in the lateral direction 18 can be configured in the same manner and orientation. The upper surface 30 has a leading edge 32 that is the end of the upper surface 30 that is forward in the rolling direction 44. The tailing edge 34 is the end of the upper surface 30 rearward in the rolling direction 44. In this regard, the leading edge 32 is forward of the tailing edge 34 in the rolling direction 44. In instances where the tread 12 is a non-directional tread 12, the leading edge 32 can be designated as either one of the edges, and the tailing edge 34 will be designated as the opposite edge of the upper surface 30 in the circumferential direction 14.

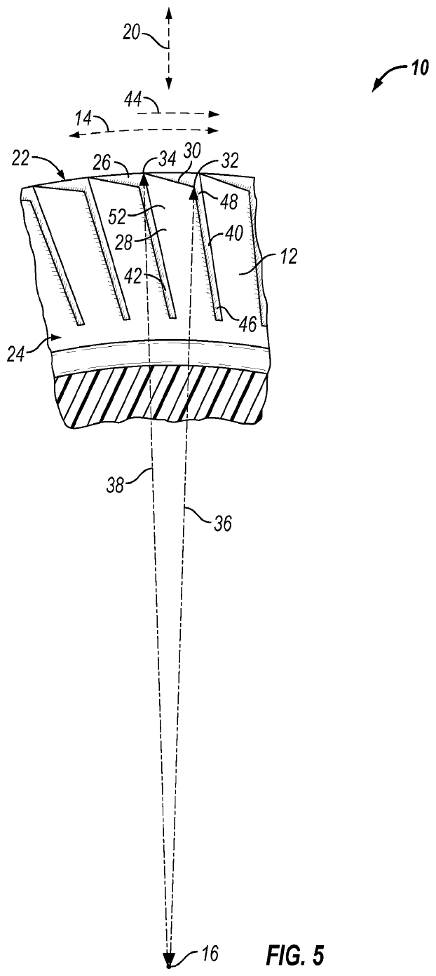

With reference in particular to FIG. 5, a side view from within the circumferential groove 24 is shown of a portion of the tread from FIGS. 3-6. The upper surface 30 is a flat surface along its entire length from the leading edge 32 to the tailing edge 34. Since the upper surface 30 is also inclined relative to the circumferential direction 14, the top of the rib elements 28 can be described as wedge shaped. The leading edge 32 is located a distance 36 to the central axis 16 as measured in the radial direction 20. The tailing edge 34 is located a distance 38 from the central axis 16 in the radial direction 20. It is to be understood that the radial direction 20 is perpendicular to the central axis 16 and thus is dependent upon the particular location being evaluated in the circumferential direction 14. In this regard, the distances 36, 38 as drawn on the figure are not parallel to one another but are perpendicular to the central axis. The placement of the central axis 16 in the figures is not to scale.

The distance 36 is shorter than the distance 34 such that the leading edge 32 is closer to the central axis 16 than the tailing edge 34 is to the central axis 16. This configuration causes the “toe” of the rib element 28 to be lower than the “heel” of the rib element 28 in relation to the rolling direction 44. A vertical force applied at the outer surface 22 toward the central axis 16 in the radial direction 20 will generate an increase in the coupling force provided due to this difference in distances 36, 38. Increasing the coupling force of the rib element 28 and micro sipe 40, 42 arrangement will further reduce irregular wear of the tread 12. It can be seen that since the difference in distances 36, 38 causes a coupling force increase, it need not be the case that the micro sipes 40, 42 be angled relative to the radial direction 20. However, the distance 36, 38 difference plus the angled micro sipes 40, 42 can compliment one another to produce a greater coupling force than either of them could alone.

The difference between distance 36 and 38 can be up to and including 2 millimeters when the spacing of the micro sipes 40, 42 in the circumferential direction 14 is 5 millimeters. A preferred distance difference between distances 36 and 38 is 1 millimeter. The difference in distances between distance 36 and 38 may be from and including 0.5 millimeters-1.5 millimeters, from and including 1.5 millimeters-2.5 millimeters, from and including 2.5 millimeters-3.5 millimeters, from and including 3.5 millimeters-4.5 millimeters, from and including 4.5 millimeters-5.5 millimeters, and from and including 5.5 millimeters-6.5 millimeters in accordance with different embodiments. The upper surface 30 when flat thus causes a continuous inclination from the leading edge 32 to the tailing edge 34. The upper surface 30 need not be flat in other embodiments and can have varying features such as steps, rounds, fillets, various inclined surfaces, or other features.

The first micro sipe 40 is inclined relative to the radial direction 20 such that a portion 46 of the first micro sipe 40 is located forward of another portion 48 of the first micro sipe 40 in the rolling direction 44. In this regard, the portion 46 is located closer to the axis 16 in the radial direction 20 than the portion 48 is located to the axis 16 in the radial direction 20. The portion 46 is thus closer to the bottom of the circumferential groove 24 and is forward in the rolling direction 44 from the portion 48 which is closer to the outer surface 22. The first micro sipe 40 is oriented at an angle to the radial direction 20 and this angle may be 8.5 degrees in some embodiments. Manufacturing capabilities set a limit on the amount of angle the first micro sipe 40 can be oriented relative to the radial direction 20. Generally, the upper limit of the angle the first micro sipe 40 can be oriented relative to the radial direction 20 is 15 degrees. With greater spacing between the first and second micro sipes 40, 42, the angle could be increased to 20 degrees. The first micro sipe 40 may thus be oriented at an angle between and including 0-20 degrees to radial direction 20. The second micro sipe 42 can be oriented relative to the radial direction 20 in a similar manner as just discussed relative to the first micro sipe 40. The orientation of the micro sipes 40, 42, and all of the micro sipes extending completely around the central axis 16 in the circumferential direction 14 at the circumferential groove 24 may all be at the same orientation angle relative to the radial direction 20. However, other embodiments are possible in which the micro sipes extending from the circumferential groove 24 have different angular orientations.

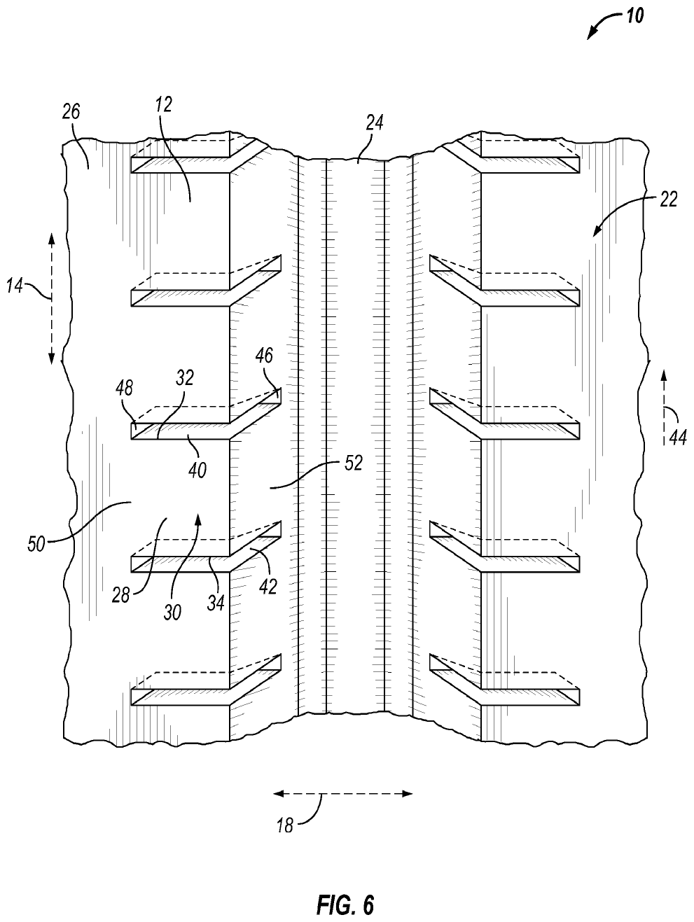

FIG. 6 shows a top view of a portion of the tread 12 of FIGS. 3-6. The rib element 28 has a first end 50 and a second end 52 that are separated from one another in the lateral direction 18. The second end 52 engages the circumferential groove 24 and defines a portion of the circumferential groove 24. The top of the second end 52 may be located at an edge of the upper surface 30 that extends from the leading edge 32 to the tailing edge 34. The bottom of the second end 52 can be the portion of the rib element 28 that extends as far into the tread 12 in the radial direction 20 as the micro sipes 40, 42 that bound the second end 52. The oppositely disposed first end 50 is located on the outer surface 22 and is likewise bound by the micro sipes 40, 42 only this time the boundary is the extent of the first and second micro sipes 40, 42 into the rib 26 in the lateral direction 18. Drawing a line between the farthest extent of the first micro sipe 40 into the rib 26 to the farthest extent of the second micro sipe 42 into the rib 26 yields the boundary of the first end 50. The boundary 50 is complete in the circumferential direction 14 because the first and second micro sipes 40, 42 extend the same distance as one another into the rib 26 in the lateral direction 18. However, if the micro sipes 40, 42 extend a different amount into the rib 26 in the lateral direction 18 the first end 50 would be angled relative to the circumferential direction 14. The rib element 28 may thus be described as being the portion of the rib 26 that is bound in the lateral direction 18 by the first and second ends 50, 52, and bound in the circumferential direction 14 by the first and second micro sipes 40, 42.

The micro sipes 40, 42 are shown as extending completely in the lateral direction 18 at the outer surface 22. However, they could in fact be angled relative to the lateral direction 18 so that the micro sipes 40, 42 have a component of extension both in the lateral direction 18 and in the circumferential direction 14 upon their extension in the outer surface 22. The micro sipes 40, 42 may extend in the lateral direction 18 a distance that is from 2 millimeters to 10 millimeters. If the length of extension were smaller than this range the micro sipes 40, 42 may not be effective in providing irregular wear protection. The preferred length of extension in the lateral direction 18 is from 4 to 6 millimeters.

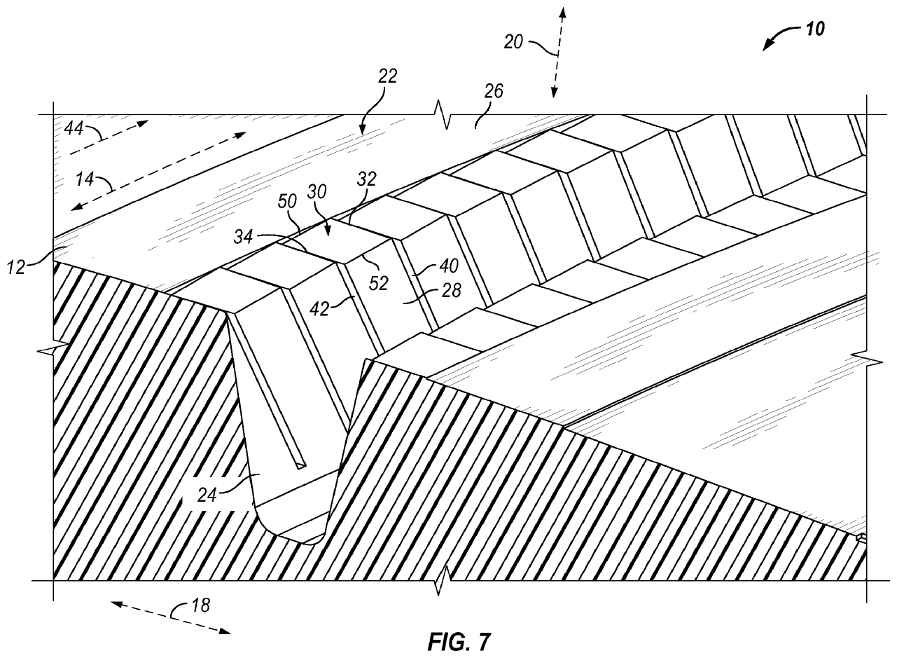

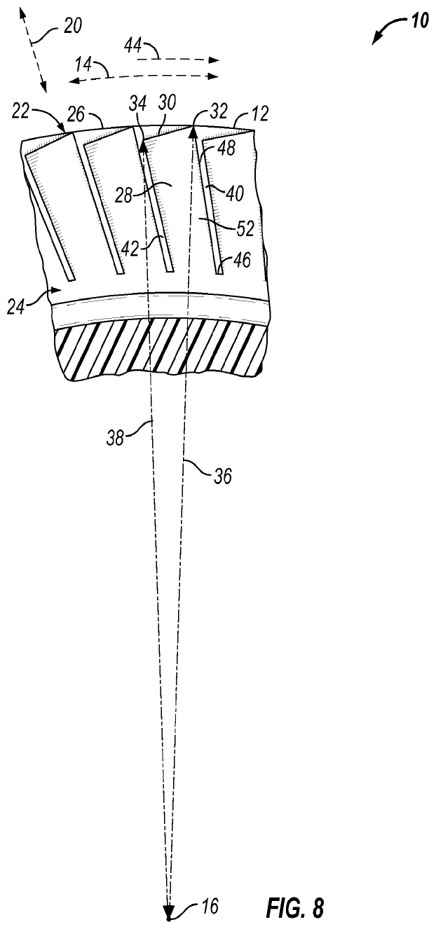

An alternate embodiment of the tread 12 is shown with reference to FIGS. 7 and 8. Here, the first and second micro sipes 40, 42 are again angled relative to the circumferential direction 14 to introduce a coupling force to the tread 12 when a vertical, radial load is applied to the tread 12 to function to reduce irregular wear on the tread 12. However, the arrangement of the upper surface 30 will work against this coupling force to reduce it so long as the tire 10 is operated in the rolling direction 44. This is because the leading edge 32 is located a longer distance 36 from the central axis 16 than the tailing edge 34 distance 38 to the central axis 16 in the radial direction 20. This arrangement is opposite to that of the one previously discussed in the FIGS. 3-6 embodiment and is not additive to the coupling force introduced by the angled micro sipes 40, 42, but is instead subtractive to the coupling force of the angled micro sipes 40, 42. The difference between the distances 36, 38 can be the same as discussed above with respect to the FIGS. 3-6 embodiment. In some embodiments, the distance 32 is 2 millimeters greater than the distance 38 in the radial direction 20. In other embodiments, the distance 32 is 1 millimeter greater than the distance 38 in the radial direction 20. It is therefore the case that the distances 36, 38 can be larger or smaller than one another in different embodiments.

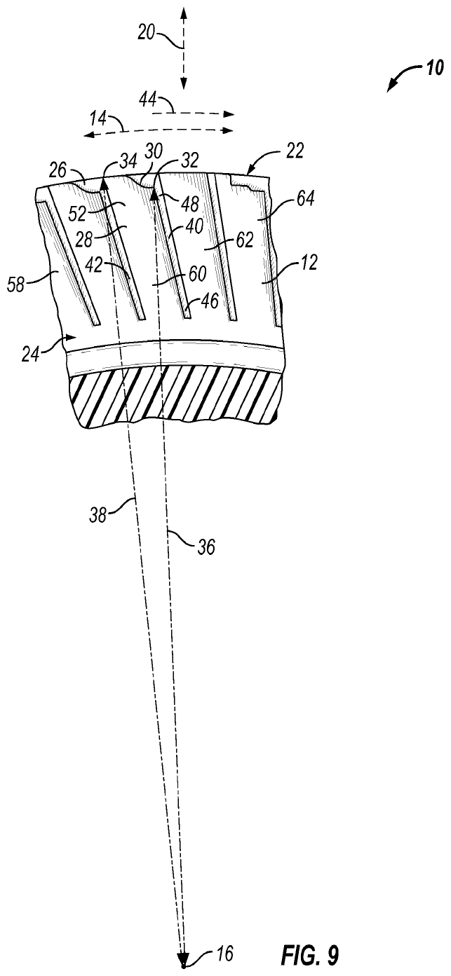

The shape of the upper surface 30 can be varied. FIG. 9 shows an alternate embodiment from the circumferential groove 24 looking in the lateral direction 18 in which four rib elements are shown and given the designations 58, 60, 62 and 64. Rib elements 58 and 60 are configured in the same manner. Rib element 60 is bound by angled micro sipes 40, 42 and has an upper surface 30 with a leading edge 32 a distance 36 to the central axis 16 in the radial direction 20, and a tailing edge 34 a distance 38 to the central axis 16 in the radial direction 20. Distance 36 is less than distance 38 to cause the rib element 60 to increase the coupling force along with the inclined micro sipes 40, 42. The upper surface 30 is not all the way from the leading edge 32 to the tailing edge 34. Instead, the upper surface 30 extends from the leading edge 32 as a rounded surface, in this case a concave shape towards the tailing edge 34 in the circumferential direction 14. Upon reaching a distance in the radial direction 20 to the central axis 16 that is at the same distance as the outer surface 22 of the rib 26 is to the central axis 16 in the radial direction 20, the upper surface 30 flattens and extends to the tailing edge 34 at the same distance to the central axis 16 as the outer surface 22 is to the central axis 16. In this regard, the distance 38 is the longest distance to the central axis 16 and a certain amount of the upper surface 30 also shares this same distance 38. The leading edge 32 is at the distance 36 and some additional portions of the upper surface 30 may also share this same distance in certain embodiments.

The orientation of the upper surface 30 is additive with the first and second micro sipe 40, 42 coupling force effect. The rib element 58 is configured the same way as the rib element 52. The rib element 62 does not have an upper surface between its micro sipes that has different distances such that its leading edge and tailing edge are located the same distance to the central axis 16 in the radial direction 20. The upper surface of the rib element 62 is the same in the radial direction 20 as the outer surface 22 of the rib 26. There is no additional coupling force generated by the upper surface of the rib element 62.

The rib element 64 is configured differently than rib elements 58, 60, 62 in that its upper surface is arranged in a stepped arrangement. The upper surface has an inward most point in the radial direction 20 at the leading edge and then steps outwards upon extension back towards the tailing edge that is the most outward point in the radial direction 20. Three steps are shown in the disclosed embodiment and more or less can be used in other embodiments. Each step can be at the same location in the radial direction 20, and convex and concave features can be used to transition from one step to the next.

The various rib elements 28 used in the tread 12 can all be the same as one another, or may be different from one another with respect to their upper surfaces 30, size, or angle as defined by the micro sipes between which they extend. Although shown as all being angled at the same orientation, the micro sipes can be variously angled in accordance with different embodiments, and all of the micro sipes extending into the same circumferential groove 24 may or may not all be angled at the same orientation.

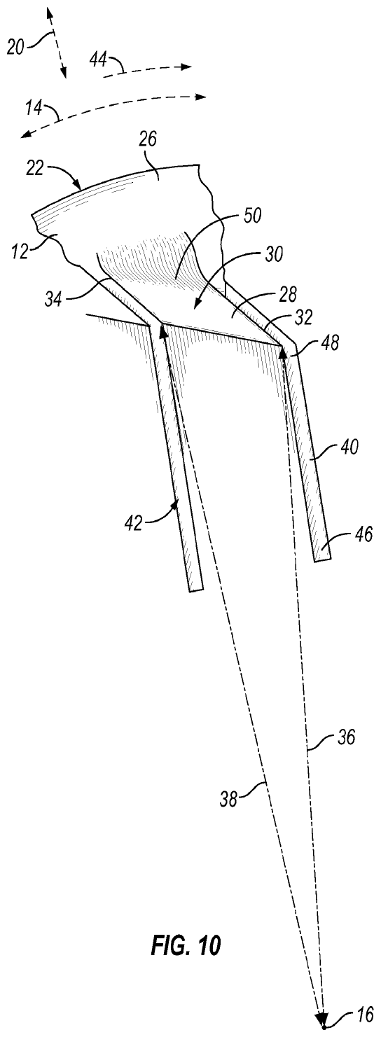

FIG. 10 shows a rib element 28 with the distance 36 again shorter than distance 38 to achieve an additive coupling force with the orientation of the micro sipes 40, 42. The transition from the upper surface 30 to the outer surface 22 of the rib 26 can be smoothed out from those shown in previous embodiments so that a stress concentration or other abrupt transition can be avoided. The first end 50 is rounded to achieve a smooth transition between the upper surface 30 and the outer surface 22 of the rib 26. The round that is present in a combination of both convex and concave, but in other embodiments only convex or only concave rounds could be used. When the first end 50 is provided with a transition, the majority of the upper surface 30 is flat. Any of the previously described embodiments can be modified from that shown to include the transition at the first end 50 of FIG. 10 or any other transition to smooth out this area of the rib 26 and rib element 28. This transition at the first end 50 could be a round that is convex, concave, or combinations there of in any amount.

The rib elements 28 with the upper surface 30 described herein can be present on any rib of the tread 12 such as the center rib, intermediate rib, shoulder rib, or sacrificial rib.

The spacing of the micro sipes 40, 42 in the circumferential direction 14, sometimes referred to as density since it determines the number per length, will also impact the irregular wear performance reduction. If the micro sipe 40, 42 spacing is small, the micro sipes 40, 42 will not be robust, and if the spacing is too large then the micro sipes 40, 42 will not be effective in fighting irregular wear. Acceptable micro sipe 40, 42 spacing is from 3 millimeters to 10 millimeters. Preferred micro sipe spacing is from 4 millimeters to 6 millimeters. Other spacing distances can be used in other embodiments.

The width of the micro sipes 40, 42 is their wall to wall distance. The widths of the micro sipes 40, 42 can be the same along their entire lengths or may vary. If varied, the widths of the micro sipes 40, 42 can be measured as the width of the majority of the length of the micro sipes 40, 42. Acceptable micro sipe 40, 42 widths may be from 0.1 to 2.0 millimeters. Preferred widths of the micro sipes 40, 42 is from 0.4 millimeters to 0.6 millimeters. Thinner micro sipes 40, 42 are not practical, and micro sipes 40, 42 greater than the acceptable range may reduce wear performance of the tread 12. Although shown as being linear in shape, the micro sipes 40, 42 could be wavy, angled, curved, non-linear, have sections of differing widths, or may be irregular in shape. A teardrop could be located at the inner portion of the micro sipes 40, 42 in the radial direction 20.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent.

1. A heavy truck tire tread, comprising:
a circumferential direction that extends about a central axis, a lateral direction that extends parallel to the central axis, and a radial direction that is perpendicular to the central axis, wherein the tread has an outer surface;
a circumferential groove that extends in the circumferential direction completely around the tread;
a rib that has a rib element that defines a portion of the circumferential groove, wherein the rib element has an upper surface in the radial direction, wherein the upper surface has a leading edge and a tailing edge in the circumferential direction, wherein the leading edge and the tailing edge are at different distances to the central axis in the radial direction, wherein the outer surface of the tread at a portion of the rib that is adjacent the upper surface of the rib element in the lateral direction is located at a same distance from the central axis in the radial direction about the circumferential direction;
a first micro sipe that extends into the rib and that opens into the circumferential groove;
a second micro sipe that extends into the rib and that opens into the circumferential groove;
wherein the rib element extends from the first micro sipe to the second micro sipe in the circumferential direction.

2. The heavy truck tire tread as set forth in claim 1, wherein the tread is a directional tread and has a rolling direction that is in the circumferential direction, and wherein the leading edge is forward of the tailing edge in the rolling direction, wherein the first micro sipe is inclined relative to the radial direction such that a portion of the first micro sipe closer to the central axis in the radial direction is forward in the rolling direction of a portion of the first micro sipe farther from the central axis in the radial direction, and wherein the second micro sipe is inclined relative to the radial direction such that a portion of the second micro sipe closer to the central axis in the radial direction is forward in the rolling direction of a portion of the second micro sipe farther from the central axis in the radial direction.

3. The heavy truck tire tread as set forth in claim 1, wherein the leading edge is closer to the central axis in the radial direction than the tailing edge is to the central axis in the radial direction.

4. The heavy truck tire tread as set forth in claim 1, wherein the tailing edge is closer to the central axis in the radial direction than the leading edge is to the central axis in the radial direction.

5. The heavy truck tire tread as set forth in claim 1, wherein the entire upper surface of the rib element is flat.

6. The heavy truck tire tread as set forth in claim 1, wherein at least a portion of the upper surface of the rib element is flat.

7. The heavy truck tire tread as set forth in claim 1, wherein the first micro sipe and the second micro sipe extend the same distance into the rib in the lateral direction from the circumferential groove, wherein the rib element has a first end that is located at the same position in the lateral direction on the tread as is the farthest extent of the first and second micro sipes into the rib in the lateral direction, wherein the rib element has a second end that engages the circumferential groove.

8. The heavy truck tire tread as set forth in claim 1, wherein the distance between the leading edge to the central axis in the radial direction is from up to and including 2 millimeters different than the distance between the tailing edge to the central axis in the radial direction.

9. The heavy truck tire tread as set forth in claim 8, wherein the distance between the leading edge to the central axis in the radial direction is 1 millimeter different than the distance between the tailing edge to the central axis in the radial direction.

10. The heavy truck tire tread as set forth in claim 1, wherein the first and second micro sipes are blind and terminate within the rib at a distance from and including 4 millimeters to 6 millimeters from the circumferential sipe in the lateral direction at the outer surface of the tread.

11. The heavy truck tire tread as set forth in claim 1, wherein the first micro sipe and the second micro sipe extend parallel to the central axis in the lateral direction and do not have a component of extension in the circumferential direction.

12. The heavy truck tire tread as set forth in claim 1, wherein the first micro sipe and the second micro sipe each have a width from and including 0.4 millimeters to 0.6 millimeters.

13. The heavy truck tire tread as set forth in claim 1, wherein the outer surface of the tread is rounded at the first end of the rib element.

14. A heavy truck tire that has the heavy truck tire tread of claim 1.
